(19) United States
(12) Patent Application Publication
(10) Pub. No.: US 2026/0310997 A1
(43) Pub. Date: Oct. 8, 2026

(54) METHOD AND SYSTEM TO CONSTRUCT KNOWLEDGE GRAPHS BASED ON A POLYSTORE

(71) Applicant: THE REGENTS OF THE UNIVERSITY OF CALIFORNIA, OAKLAND, CA (US)

(72) Inventors: AMARNATH GUPTA, SAN DIEGO, CA (US); SUBHASIS DASGUPTA, SAN DIEGO, CA (US); JON STEPHENS, POWAY, CA (US); SHENGQI LI, LA JOLLA, CA (US)

(73) Assignee: THE REGENTS OF THE UNIVERSITY OF CALIFORNIA, OAKLAND, CA (US)

(21) Appl. No.: 19/307,954

(22) Filed: Aug. 22, 2025

Related U.S. Application Data
(60) Provisional application No. 63/685,797, filed on Aug. 22, 2024.

(51) Int. Cl. G06N 5/025

(52) U.S. Cl. CPC G06N 5/025

(57) ABSTRACT

Apparatus, systems and methods are provided that create an improved declarative and inference-guided construction of ontology-aligned knowledge graphs across heterogeneous data sources. The disclosed embodiments leverage indexing, mapping, and federated querying across relational, document, graph, and search-based sources through a unified metadata model. They use the polystore as a federated query layer, and as a structured semantic substrate for rule-based knowledge graph generation.

### STATEMENT OF GOVERNMENT SUPPORT

This invention was made with government support under 1909875 awarded by the National Science Foundation. The government has certain rights in the technology.

### CROSS REFERENCE TO RELATED APPLICATIONS

This application claims the benefit of the filing date of U.S. Provisional Patent Application Ser. No. 63/685,797, entitled: “METHOD AND SYSTEM TO CONSTRUCT KNOWLEDGE GRAPHS BASED ON A POLYSTORE” (the “Provisional Application”), which was filed in the USPTO on Aug. 22, 2024, and which includes at least some of the same inventors. The Provisional Application is hereby incorporated by reference as if fully set forth herein.

### FIELD OF TECHNOLOGY

The technology of the application relates generally to improved knowledge graph construction, ontology engineering, and multi-modal data integration and more specifically, but not exclusively to improved declarative and inference-guided construction of ontology-aligned knowledge graphs across heterogeneous data sources building upon a polystore data architecture.

### BACKGROUND OF TECHNOLOGY

Conventional systems and methods for constructing declarative knowledge graphs such as R2RML, RML, and P2KG-support mapping over structured or semi-structured data using predefined templates. However, they do not extend to unstructured text, Large Language Model (LLM)-inferred mappings, or dynamically evolving schemas. They also lack the ability to express constraints across data modalities or dynamically reason over index metadata, embedding similarity, or ontology-based definitions.

Furthermore, most users are unable to write declarative mapping rules due to a lack of schema knowledge. Existing tools offer little automation or guidance. Structural heterogeneity compounds the challenge, as entity concepts may be represented as table names, column values, or nested array elements, making schema alignment and ontology integration difficult.

Existing systems also fail to capture cross-modal semantic constraints. Examples may include: “Create an edge between an entity extracted from text and a product ID in JSON” or “Omit this node if the LLM-derived category contradicts the SQL-based type annotation.” These forms of reasoning require integrated access to structured bindings and semantic annotations.

Conventional ontology augmentation methods are also either manual, or rule based. They typically operate outside the data integration loop and cannot adapt to user competency questions or hybrid entity definitions that span multiple sources and modalities. This limits their ability to support dynamic, context-aware, and domain-sensitive graph construction workflows.

In view of these deficiencies in conventional systems and methods for constructing declarative knowledge graphs, the disclosed technology provides systems and methods for combining rule-driven and LLM-inferred mappings, polystore-native rule execution, and ontology-guided refinement into a unified framework for heterogeneous knowledge graph construction.

### SUMMARY OF TECHNOLOGY

Many advantages will be determined and are attained by the disclosed technology, which in a broad sense provides systems and methods for generating knowledge graphs. One or more embodiments, provide improved declarative and inference-guided construction of ontology-aligned knowledge graphs across heterogeneous data sources building upon a polystore data architecture.

In one or more implementations of the technology, a system is provided for constructing a knowledge graph from a data source. The system may include a rule engine configured to apply at least one graph-generating dependency rule to the data source. The graph-generating dependency rule conforms to a graph-generating dependency language. The system may also include a schema inference engine configured to map a schema and data from the data source into at least one graph element. They system may also include a conversion module configured to transform the schema generated by the inference engine into executable graph generating dependencies and a unified engine for executing rules.

In one or more implementations of the technology, a computer-implemented method for constructing a knowledge graph from a data source is provided such that at least a portion of the method is performed by a computing device that includes at least one processor. The method may include inferring a semantic mapping from a schema and a sample data using a large language model applied to the data source. The method may also include generating a declarative graph-generating dependency rule from the semantic mapping. The method may include executing the declarative graph-generating dependency rule to produce a graph node and a graph edge and generating a user defined rule and merging the user defined rule with an inferred rule into a unified execution plan.

In one or more implementations of the technology a non-transitory computer-readable medium having one or more computer-executable instructions that, when executed by at least one processor of a computing device, cause the computing device to communicate with a data source is provided. The instructions may cause the computing device to infer a semantic mapping from a schema and a sample data using a large language model applied to the remote data source. The instructions may also cause the computing device to generate a declarative graph-generating dependency rule from the semantic mapping and execute the declarative graph-generating dependency rule to produce a graph node and a graph edge. The instructions may cause the computing device to merge a user defined rule and an inferred rule into a unified execution plan.

Features from any of the above-mentioned embodiments and/or examples may be used in combination with one another in accordance with the general principles described herein. These and other embodiments, features, and advantages will be more fully understood upon reading the following detailed description in conjunction with the accompanying drawings and claims.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain principles associated with the disclosed implementations. In the drawings like reference characters refer to like parts throughout, and in the drawings:

FIG. 1 illustrates an exemplary graph generated dependency rule language and execution semantics in accordance with one or more embodiments of the technology;

FIG. 2 illustrates an exemplary rule set for a multi-modal farm product graph with ontological anchoring in accordance with one or more embodiments of the technology;

FIG. 3 illustrates an exemplary set of rules to provide the integration of LLM-inferred bindings and declarative sources within a polystore-based graph generated dependency system in accordance with one or more embodiments of the technology;

FIG. 4 illustrates an exemplary legal, spatial, and ontological graph construction for food business compliance in accordance with one or more embodiments of the technology;

FIG. 5 illustrates an exemplary competency questions and entity extraction in accordance with one or more embodiments of the technology;

FIG. 6 illustrates an exemplary graph generated dependency integration of predicted relations in accordance with one or more embodiments of the technology;

FIG. 7 illustrates an exemplary computer system in accordance with one or more embodiments of the technology;

The technology will next be described in connection with certain illustrated embodiments and practices. However, it will be clear to those skilled in the art that various modifications, additions, and subtractions can be made without departing from the spirit or scope of the claims.

### DETAILED DESCRIPTION

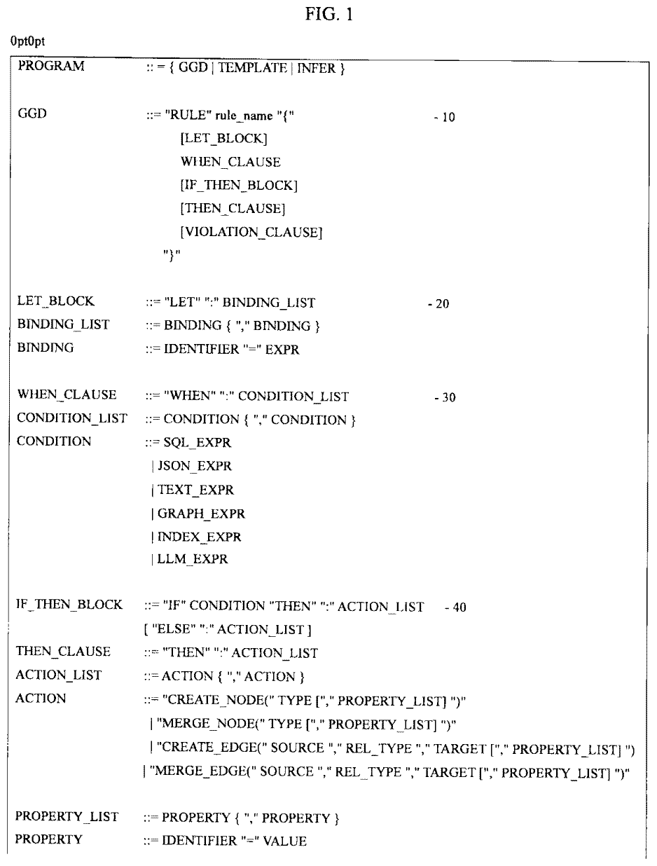

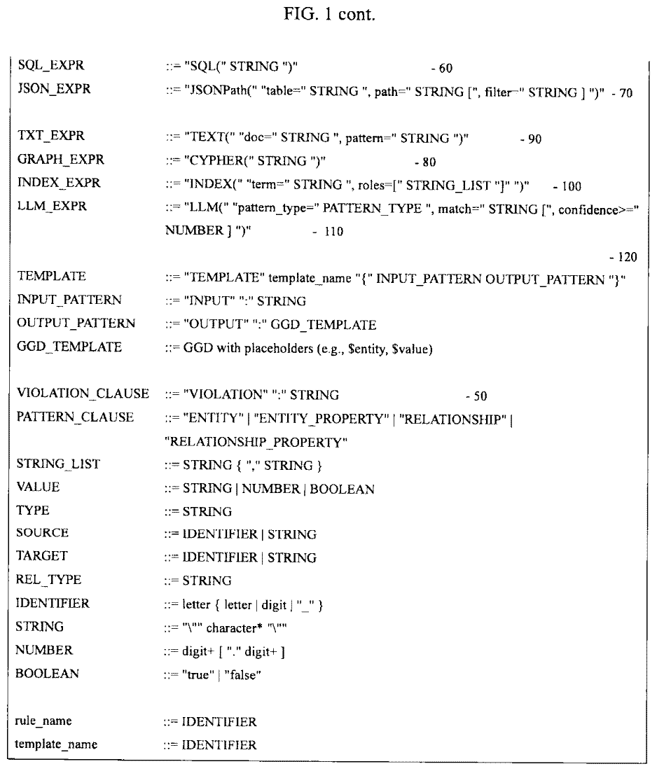

Referring to the drawings in detail wherein like reference numerals identify like elements throughout the various figures, illustrated in FIGS. 1-7 are systems and methods for improving knowledge graph generation.

Discussion of an embodiment, one or more embodiments, an aspect, one or more aspects, a feature, one or more features, or a configuration or one or more configurations, an instance or one or more instances is intended be inclusive of both the singular and the plural depending upon which provides the broadest scope without running afoul of the existing art and any such statement is in no way intended to be limiting in nature. Technology described in relation to one or more of these terms is not necessarily limited to use in that embodiment, aspect, feature or configuration and may be employed with other embodiments, aspects, features and/or configurations where appropriate.

In the descriptions and claims herein, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” is intended to mean, “based at least in part on,” such that an unrecited feature or element is also permissible.

U.S. Pat. No. 11,288,261 entitled “Data Ingestion into a Polystore” and 11,693,856 entitled “Query Processing in a Polystore”, both of which disclosures are incorporated herein by reference as if fully set forth, disclose architecture and query optimization framework for polystore systems. The subject of these patents enable indexing, mapping, and federated querying across relational, document, graph, and search-based sources through a unified metadata model.

Technology disclosed herein leverages these capabilities by using the polystore as both a federated query layer, and as a structured semantic substrate for rule-based knowledge graph generation. Data from diverse modalities is ingested and indexed by the polystore. Each modality retains its native structure but may be accessible through a uniform interface that supports rich querying, structured binding, and cross-modal joins. The Graph Generating Dependencies (GGD) engine introduced here is layered on top of this polystore and issues logical queries that retrieve structured fragments (rows, trees, subgraphs, records, etc.) and compose them into graph-level transformations under the guidance of an ontology.

One or more embodiments, provides a hybrid declarative and inference-driven system for constructing ontology-grounded knowledge graphs from structurally and semantically heterogeneous data sources. The system introduces a GGD language that supports both human-authored and LLM-synthesized rules, unifying data from SQL, JSON, Cypher, unstructured text, and language models under a common semantic transformation framework. GGD may be a mathematical formalism to express and infer from graph-centric rules.

A multi-modal rule execution engine operates within a polystore architecture. Each GGD rule may contain one or more LET clauses that retrieve and bind complex data structures-such as trees, arrays, or graph fragments-which are navigated through a path-aware intermediate representation. Rule execution supports snapshot-consistent evaluation, nested unrolling of structured values, conditional branching, and constraint-based conflict resolution.

A schema inference module leverages LLM to suggest entity and relationship roles for attributes, nested structures, and documents. These inferences are transformed into fully executable GGD rule templates that preserve explainability and traceability.

The system includes an Anchored Semantics framework, which interprets competency questions and ontology terms to generate task-specific refinements. Entities and relationships are embedded using a fusion of lexical, hierarchical, and definitional features, and graph completion is guided by attention-based link prediction over co-occurrence and ontology-derived edges.

By embedding the execution semantics within a polystore that harmonizes relational, document, graph, search, and LLM-based inputs, the system may achieve data consistency, expressive rule logic, and semantic relevance. This also addresses challenges of schema evolution, structural misalignment, and rule accessibility, enabling scalable, ontology-aligned knowledge graph construction across diverse domains.

### GGD Rule Language and Execution Semantics (FIG. 1)

GGD rules 10 specify how structured or unstructured source data is transformed into nodes and edges in a target knowledge graph. Each GGD rule may be a self-contained transformation unit that includes optional LET bindings 20 to fetch external data, a WHEN clause 30 that evaluates logical conditions over the data, and optional IF—THEN—ELSE, THEN, 40 and VIOLATION clauses 50. These form a declarative execution pipeline for deriving or constraining graph content.

The GGD rule language is formally defined by the grammar shown in FIG. 1, which supports multi-modal expressions such as SQL 60, JSONPath 70, Cypher 80, text search 90, indexed metadata 100, and LLM-based pattern extraction 110. It also includes support for templates 120 and inference directives to enable modularity and hybrid rule generation.

Each rule executes over a snapshot-consistent, polystore-coordinated environment, where external data sources are queried, filtered, and assembled into structured bindings. These bindings drive the rule logic to construct graph elements, subject to conditional logic and constraint enforcement. The combined execution of multiple rules follows a fixpoint iteration strategy with dependency-aware scheduling, conflict resolution, and mutation memorization.

### Polystore Integration and Structured Binding Semantics

Role of the Polystore: The execution of GGD programs is intended for a polystore system, which allows the knowledge graph construction engine to interact with heterogeneous data sources using native connectors, while offering a unified logical abstraction for rule evaluation.

Supported modalities include:
Relational databases (e.g., PostgreSQL, MySQL) for structured tabular data;
Document stores (e.g., JSON, MongoDB, XML) for deeply nested or hierarchical records;
Graph databases (e.g., Neo4j, RDF triple stores) for querying property graphs or semantic triples;
Full-text search engines (e.g., Solr, Elasticsearch) for inverted index-based entity matching;
Vector stores for dense embeddings of entities or relationships;
LLM-powered inference engines for entity/relation extraction from text or schema samples.

The Polystore facilitates seamless cross-model operations such as joining rows from a SQL table with objects in a JSON document or linking an LLM-extracted entity to a subgraph pattern retrieved via Cypher. This unified abstraction layer eliminates the need for flattening, ETL pre-processing, or prior materialization of intermediary structures.

Structured Binding Representation: LET bindings can return complex values: scalars, records, arrays, deeply nested trees, or entire subgraphs. The polystore provides a typed intermediate representation (IR) that supports:
Path navigation: Users can refer to fields such as x.items [0].price regardless of the source modality.
Unnesting and iteration: Arrays or list fields are exposed as iterable bindings usable in graph generation logic.
Graph projections: Cypher queries can return sets of nodes and edges, which are stored as in-memory subgraphs accessible via symbolic variables.

This abstraction allows declarative rule writers to access structured values consistently, even when drawn from deeply nested or modality-specific representations.

Snapshot Consistency and Provenance: Rule execution is snapshot-consistent: LET clauses may be evaluated on a fixed view of the polystore, ensuring deterministic behavior even under concurrent access or dynamic data. For each rule firing, the system records:
The snapshot version of each accessed source;
A binding hash identifying the specific LET evaluation;
The rule ID and execution round;
Any mutation tags or conflicts detected during graph update.

This provenance mechanism enables reproducibility, conflict tracing, and reasoning over graph construction history.

Composability and Multi-Modal Joins: A benefit of a polystore architecture is native support for cross-modal joins and constraint evaluation:
Cross-modal joins: Bindings from SQL, JSONPath, and Cypher can be compared and aligned by shared keys or semantic roles (e.g., x.productId=y.ref.id).
Type-safe coercion: Structured representations are converted to a normalized schema-aware format enabling deep comparisons and joins.
Inference-aware logic: LLM-derived bindings can be joined with concrete records or schema metadata, creating hybrid reasoning workflows.

These capabilities allow GGDs to enforce constraints and generate links across boundaries of format and semantics.

Conflict Resolution and Fixpoint Iteration: When multiple rules contribute overlapping edits (e.g., merging the same node with different property sets), the system applies rule coordination and resolution strategies:
Priority-based execution: Rules may be ordered based on declared precedence or dependency graphs.
Fixpoint iteration: The engine re-applies rules until the graph reaches a stable state, memoizing prior applications to avoid redundant work.
Custom conflict policies: Merging strategies can be configured as last-writer-wins, property unification, or VIOLATION-based rejection.

Polystore-Based Execution is Useful: The polystore-native GGD execution model:
Enables late binding of schema semantics—rules can operate without prior data flattening;
Leverages native execution plans for each backend while abstracting over their differences;
Unlocks hybrid rules that reason jointly over structured data, ontologies, and free text.

This architecture transforms GGD rule evaluation from a format-specific operation into a semantically integrated, scalable, and extensible pipeline for knowledge graph construction in real-world heterogeneous data landscapes.

### Ontology-Anchored Graph Refinement and Completion

Competency Question Extraction and Ontology Anchoring: The system processes a bank of competency questions (CQs) alongside a base ontology. Each CQ is parsed by an LLM to extract candidate entities and relationships. For each entity:
If found in a dictionary of known terms, it is marked as grounded.
Otherwise, an LLM generates a concise definition.
Definitions may recursively refer to other terms, resolved until a consistent DAG is constructed.

The output is a partially aligned taxonomy over user-specified questions, structured as a subClassOf hierarchy enriched with anchors from the input ontology.

Embedding and Attention-Based Fusion: Each entity e is embedded using three modalities:
Label embedding from the term itself,
Hierarchy embedding from its path in the DAG,
Definition embedding from the generated or known description.

These embeddings are fused using a self-attention mechanism trained via distant supervision from knowledge corpora (e.g., OpenAlex or domain text). The result is a rich semantic representation capturing lexical, taxonomic, and definitional nuance.

Graph Completion via Graph Attention Network and Link Prediction: The system constructs an augmented graph:
‘Nodes are entities from CQs and ontology,
Edges are co-occurrence links from shared questions,
A Graph Attention Network (GAT) propagates and refines embeddings.

For each candidate link (e₁, e₂), a classifier labels it with a semantic relationship (e.g., regulates, enables, depends-on). These labeled edges are then merged back into the ontology-aligned graph, improving coverage and coherence.

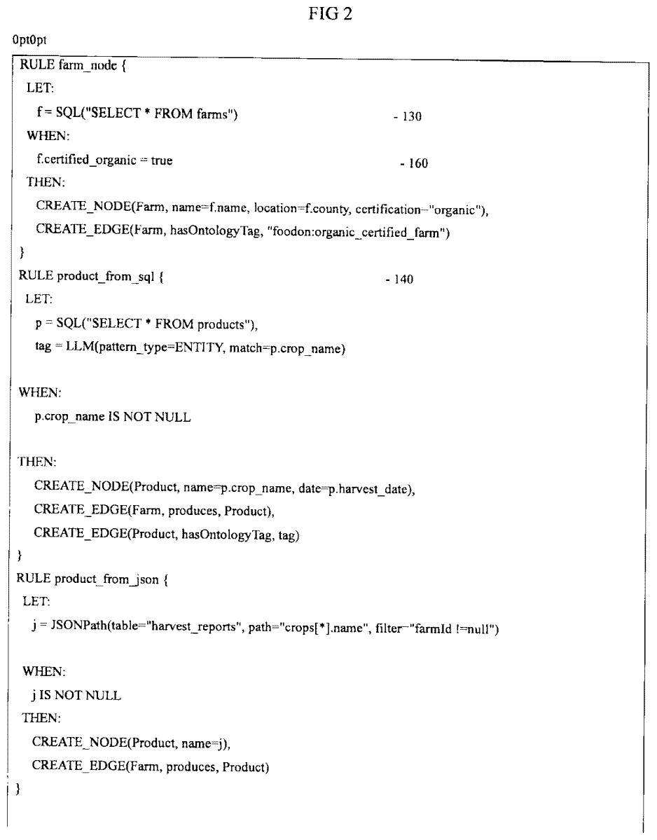

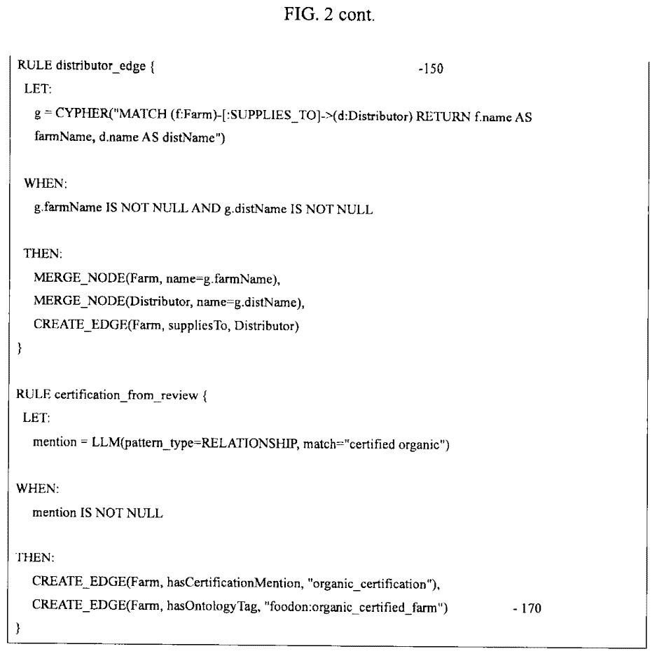

### Example: Multi-Modal Farm Product Graph with Ontological Anchoring (FIG. 2)

The exemplary embodiment illustrated in FIG. 2 constructs a knowledge graph representing local farms 130, the food products they produce 140, the distributors they work with 150, and associated organic certifications 160. Data is sourced from SQL, JSON, graph, and unstructured text, and aligned to FOODON ontology concepts 170.

The graph produced by these rules reflects a semantically grounded traceability map from farms to their products, distribution partners, and third-party evidence of certification. All food product nodes are aligned with FOODON categories using LLM-aided entity recognition.

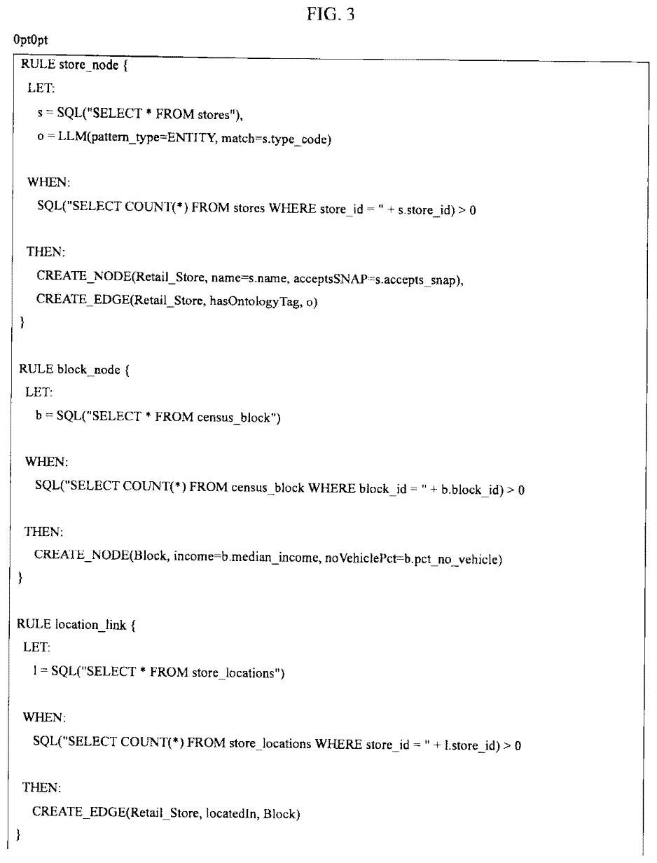

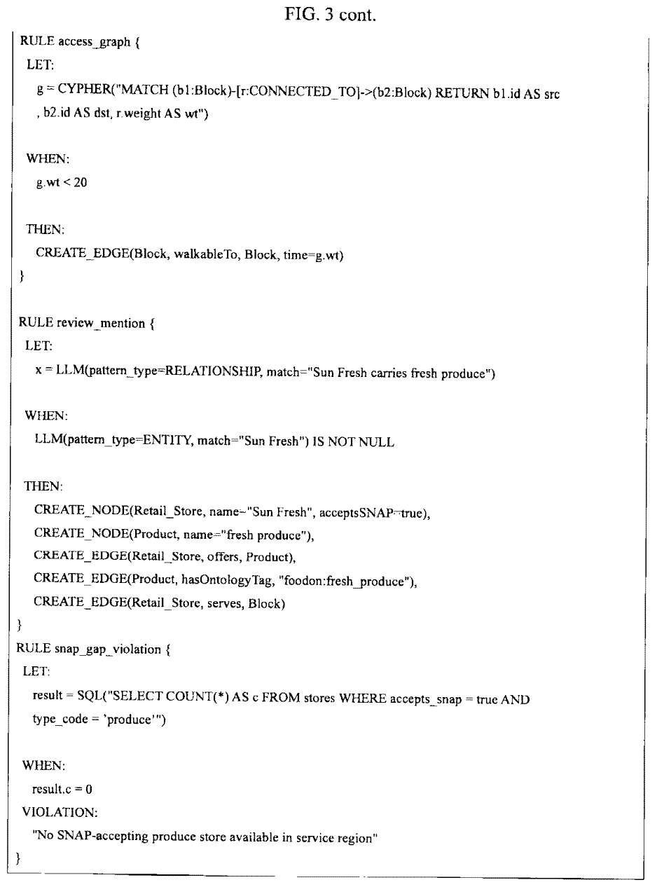

### LLM-Inferred and Declarative GGD Integration for Food Access Graphs (FIG. 3)

The exemplary rules illustrated in FIG. 3 provide the integration of LLM-inferred bindings and declarative sources within a polystore-based GGD system. All syntax conforms to the GGD rule grammar.

Each rule satisfies the grammar: all LET, WHEN, and THEN blocks are defined explicitly; LLM and Cypher expressions are bound to identifiers before use; and property assignments and edge targets are resolved through valid symbolic bindings.

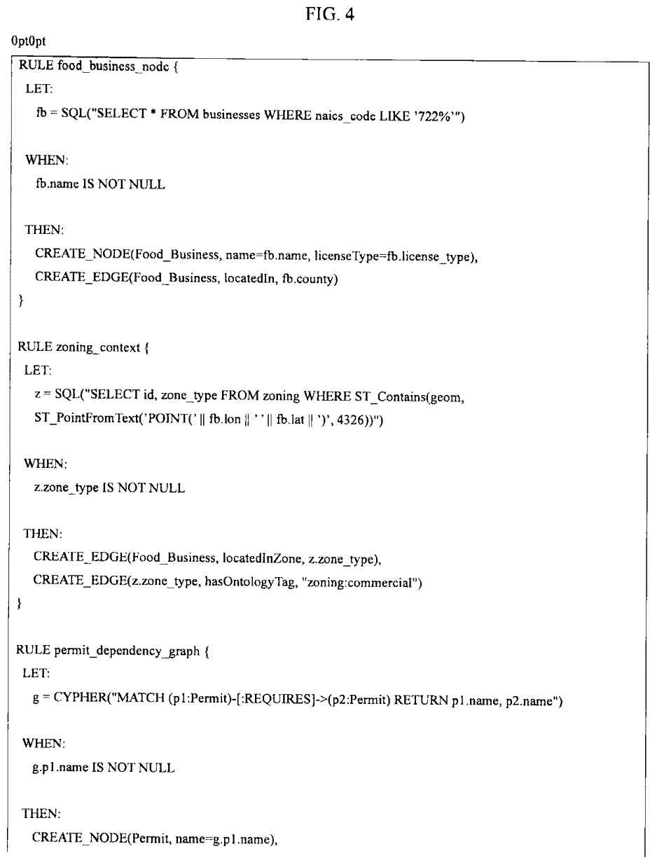

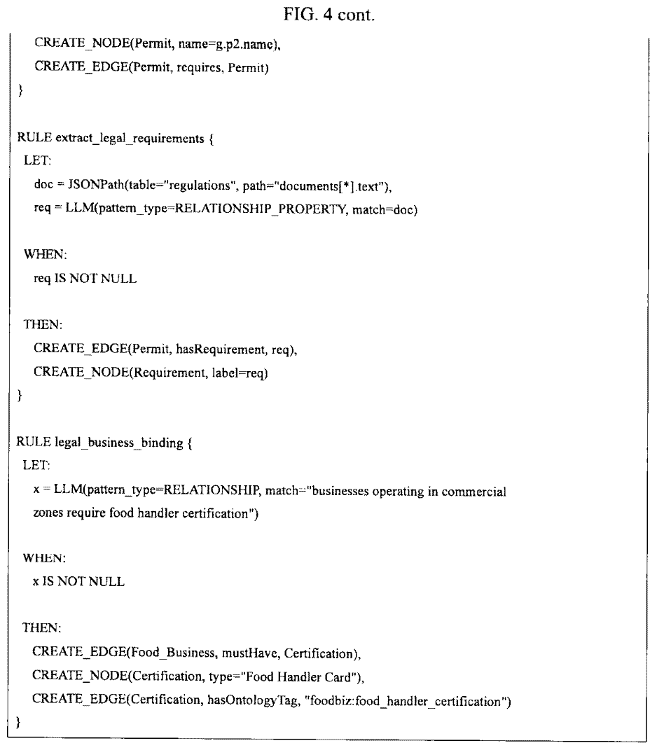

Legal, Spatial, and Ontological Graph Construction for Food Business Compliance (FIG. 4) This exemplary embodiment (FIG. 4) creates a knowledge graph linking food businesses to their regulatory obligations, zoning context, and legal permit relationships. It integrates structured spatial data, unstructured legal text, graph-structured permit rules, and food domain ontologies.

This graph enables questions such as: “What permits and certifications are required for a food truck in a mixed-use zone?” or “Which businesses are operating without satisfying legal dependencies?” All legal nodes and edges are annotated with ontology tags from a domain-specific food business ontology and geoenriched via PostGIS containment logic.

### Competency-Question-Guided Graph Completion via Anchored Semantics

The following exemplary embodiment demonstrates how a set of competency questions may be used to guide the refinement and augmentation of a food system knowledge graph. The approach employs the Anchored Semantics framework, combining ontology anchoring, attention-based embedding fusion, and graph-based link prediction.

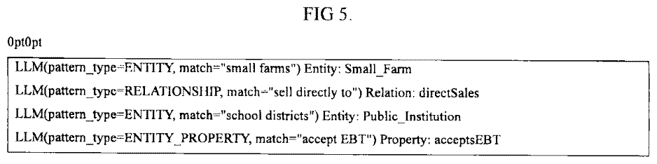

### Step 1: Competency Questions and Entity Extraction (FIG. 5)

Given the following competency questions:
“Which small farms sell directly to school districts?”
“What licenses are required for cottage food producers in San Diego?”
“Which food businesses in low-income neighborhoods accept EBT?”
   An LLM extracts candidate entity mentions and assigns them to semantic types as illustrated in FIG. 5.

### Step 2: Ontology Anchoring and Entity Definition

Each extracted term is anchored into a domain ontology by checking:
Distant supervision dictionary: For known definitions.
LLM-based definition synthesis: If not found, generate a one-sentence definition.

Definitions are recursively expanded and converted into a clean subClassOf DAG.

### Step 3: Embedding and Attention Fusion

Each anchored entity is embedded using three facets:
Label embedding (vₙ) from entity text;
Path embedding (v_{C}) from hierarchical position;
Definition embedding (v_{d}) from LLM-generated text.

These vectors are fused via a self-attention mechanism:
[vₙ, v_{C}, v_{d}]→Attention→V_{entity}

### Step 4: Graph-Based Completion

A graph is constructed with:
Nodes: Entities extracted from CQs;
Edges: Co-occurrence links between entities appearing in the same question.

A Graph Attention Network (GAT) computes contextualized embeddings and predicts likely missing edges. Each predicted link is labeled with a relationship type using a fine-tuned classifier.

### Step 5: GGD Integration of Predicted Relations

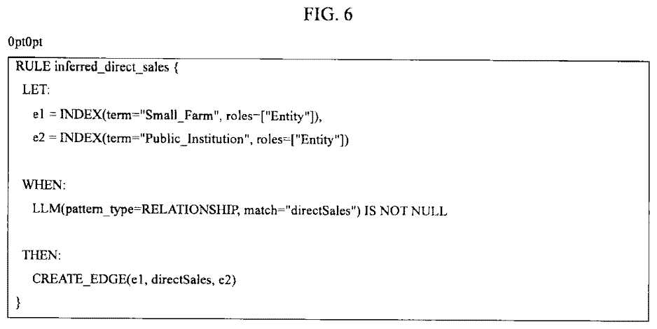

Predicted links are converted into GGD rules as illustrated in FIG. 6. These GGD rules are merged into the knowledge graph construction pipeline, completing the ontology with relations aligned to competency-driven user needs.

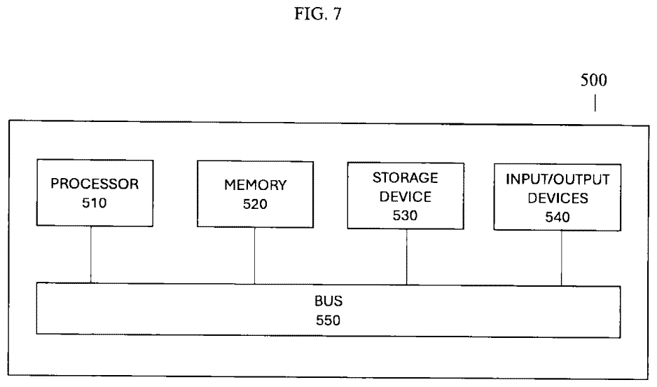

In one or more implementations, one or more of the aspects disclosed may be implemented in a computing system, such as a computing system 500 depicted at FIG. 7. The system may include a processor 510, a memory 520, a storage device 530, and input/output device 540. The processor 510, the memory 520, the storage device 530, and the input/output device 540 can be interconnected via a system bus 550. The processor 510 is capable of processing instructions for execution within the computing system 500. In some implementations of the current subject matter, processor 510 can be a single-threaded processor. Alternately, processor 510 can be a multi-threaded processor. Processor 510 is capable of processing instructions stored in memory 520 and/or on the storage device 530 to display graphical information for a user interface provided via the input/output device 540. The memory 520 is a computer-readable medium such as volatile or non-volatile that stores information within the computing system 500. The storage device 530 is capable of providing persistent storage for the computing system 500. The storage device 530 can be a floppy disk device, a hard disk device, an optical disk device, or a tape device, or other suitable persistent storage means. The input/output device 540 provides input/output operations for the computing system 500. In one or more implementations the input/output device 540 includes a keyboard and/or pointing device. In one or more implementations, the input/output device 540 includes a display unit for displaying graphical user interfaces. According to one or more implementations, the input/output device 540 can provide input/output operations for a network device. For example, the input/output device 540 can include Ethernet ports or other networking ports to communicate with one or more wired and/or wireless networks (e.g., a local area network (LAN), a wide area network (WAN), the Internet). In some implementations, computing system 500 can be used to execute various interactive computer software applications that can be used for organization, analysis and/or storage of data in various formats. Alternatively, computing system 500 can be used to execute any type of software applications. These applications can be used to perform various functionalities, e.g., planning functionalities, computing functionalities, communications functionalities, etc. The applications can include various add-in functionalities or can be standalone computing products and/or functionalities. Upon activation within the applications, the functionalities can be used to generate the user interface provided via the input/output device 540. The user interface can be generated and presented to a user by the computing system 500 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

Having described the technology, what is claimed as new and secured by Letters Patent is:

1. A system for constructing a knowledge graph from a structured or semi-structured data source, the system comprising:
a rule engine configured to apply at least one graph-generating dependency rule to the data source; wherein the at least one graph-generating dependency rule conforms to a graph-generating dependency language;
a schema inference engine configured to map a schema and data from the data source into at least one graph element;
a conversion module configured to transform the schema generated by the inference engine into executable graph generating dependencies; and
a unified engine for executing rules.

2. The system according to claim 1 wherein the data source is a heterogenous data source; the rule engine is a declarative rule engine; the graph-generating dependency language is multi-modal; the schema inference engine utilizes large language model prompting; and the unified engine executes user-authorized and inferred rules.

3. The system according to claim 1 wherein the data source is utilized as a plurality of snapshots.

4. The system according to claim 1, wherein the graph-generating dependency language supports at least one function from the group consisting of SQL, JSONPath, Cypher, text pattern matching, and large language model derived entity and relation clauses.

5. The system according to claim 1 wherein the unified engine is configured to detect at least one constrain violation.

6. The system according to claim 1 wherein the data source is a polystore.

7. The system according to claim 1 further including a template to bind large language model output to a graph generating dependency rule.

8. A computer-implemented method for constructing a knowledge graph from a remote structured or semi-structured data source, at least a portion of the method being performed by a computing device comprising at least one processor, the method comprising:
the computer communicating with a remote data source,
the computer inferring a semantic mapping from a schema and a sample data using a large language model applied to the remote data source;
the computer generating a declarative graph-generating dependency rule from the semantic mapping;
the computer executing the declarative graph-generating dependency rule to produce a graph node and a graph edge; and
the computer generating a user defined rule and merging the user defined rule with an inferred rule into a unified execution plan for knowledge graph construction.

9. The computer-implemented method according to claim 8 further including the computer applying a plurality of competency questions to a snapshot of the data source.

10. The computer-implemented method according to claim 9 further including the computer applying a plurality of competency questions to another snapshot of the data source.

11. The computer-implemented method according to claim 9 further including the computer extracting an entity from the competency questions using a large language model; looking up a definition of the entity in a distant-supervision dictionary; recursively generating a plurality of definitions for the entity when the definition is not located in the distant-supervision dictionary; and constructing a subclass of a directed acyclic graph based on the definitions.

12. The computer-implemented method according to claim 11 wherein the entity has a label and a hierarchical path, the method further including the computer generating a vector embedding for the entity label using a tuned language model; generating a vector embedding for the entity hierarchical path; generating a vector embedding for the entity definition; fusing the vector embedding for the label, the vector embedding for the hierarchical path and the vector embedding for definition into a representation.

13. The computer-implemented method according to claim 9 further including the computer deriving a co-occurrence edge from the competency questions; applying a Graph Attention Network to propagate an entity embedding over a neighborhood; using a scoring function to predict a link between a plurality of entities; and classifying a predicted link into a relationship type.

14. The computer-implemented method according to claim 8 wherein the data source includes a table, a column, and an array field, the computer-implemented method respectively modelling the table, the column, and the array field as a model selected from the group consisting of an entity, a relationship, and an attribute.

15. A non-transitory computer-readable medium comprising one or more computer-executable instructions that, when executed by at least one processor of a computing device, cause the computing device to:
communicate with a structured or semi-structured data source;
infer a semantic mapping from a schema and a sample data using a large language model applied to the data source;
generate a declarative graph-generating dependency rule from the semantic mapping;
execute the declarative graph-generating dependency rule to produce a graph node and a graph edge; and
merge a user defined rule and an inferred rule into a unified execution plan for for knowledge graph construction.

16. The non-transitory computer-readable medium according to claim 15, wherein the computer-executable instructions further cause the computing device to apply a plurality of competency questions to a snapshot of the data source.

17. The non-transitory computer-readable medium according to claim 16, wherein the computer-executable instructions further cause the computing device to extract an entity from the competency questions using a large language model; look up a definition of the entity in a distant-supervision dictionary; generate a definition for the entity when the definition is not located in the distant-supervision dictionary; and construct a subclass of a directed acyclic graph based on the definition.

18. The non-transitory computer-readable medium according to claim 17, wherein the entity has a label and a hierarchical path, the computer-executable instructions further cause the computing device to generate a vector embedding for the entity label using a tuned language model; generate a vector embedding for the entity hierarchical path; generate a vector embedding for the entity definition; and fuse the vector embedding for the label, the vector embedding for the hierarchical path and the vector embedding for definition into a representation.

19. The non-transitory computer-readable medium according to claim 17, the computer-executable instructions further cause the computing device to derive a co-occurrence edge from the competency questions; apply a Graph Attention Network to propagate an entity embedding over a neighborhood; use a scoring function to predict a link between a plurality of entities; and classify a predicted link into a relationship type.

20. The non-transitory computer-readable medium according to claim 15, wherein the data source includes a table, a column, and an array field, the computer-executable instructions further cause the computing device to respectively model the table, the column, and the array field as a model selected from the group consisting of an entity, a relationship, and an attribute.
